(19) United States
(12) Patent Application Publication
(10) Pub. No.: US 2018/0344578 A1
(43) Pub. Date: Dec. 6, 2018

(54) Baby Pacifier Holder

(71) Applicants: Nathan Briggs, Ilderton (CA); Sara Jane Briggs, Ilderton (CA)

(72) Inventors: Nathan Briggs, Ilderton (CA); Sara Jane Briggs, Ilderton (CA)

(21) Appl. No.: 15/606,496

(22) Filed: May 26, 2017

Related U.S. Application Data
(60) Provisional application No. 62/403,089, filed on Oct. 1, 2016.

(51) Int. Cl. A61J 17/00; B65D 25/04; B65D 41/04; B65D 51/16

(52) U.S. Cl. CPC A61J 17/001; B65D 51/1605; B65D 41/04; B65D 25/04

(57) ABSTRACT

Our baby pacifier container is a design that came to fruition when my wife Sara who works in the childcare field noticed that many parents used plastic zip loc bags to carry and transport their children's pacifiers. When asked why they do this, the parents replied that there is nothing on the market that will do the job of protecting their pacifiers. My wife and I decided to do a lot of research on this by visiting shops, looking online and asking around. We could not find a product that did everything that parents needed. We wanted to design a container that was strong, safe durable and aesthetically pleasing to the eye. It also had to be a practical and useful product. Straight away we knew we had to design our own container that would fulfil all of the needs of parents. So together we drew and designed a container that ticked all the boxes. Our container keeps pacifiers safe, clean and easy to access. The BPA free dishwasher safe polypropylene, is strong, light and durable. Parents can be assured that their expensive pacifiers will stay safe and clean.

### BACKGROUND TO THE INVENTION

In our research we have found that many parents use plastic bags, or other items to store their baby's pacifiers. This can cause cross contamination as clean and dirty pacifiers can get mixed together or can touch each other spreading germs. Pacifiers can be expensive and without adequate protection they can be crushed or damaged. Some designers have tried to solve the problem by manufacturing cloth bags to carry pacifiers, this in our opinion does not solve the problem of keeping the pacifier hygienically clean. These bags will only hold 1 pacifier and if 2 are squeezed in there is risk of cross contamination. The bags lack the strength and durability needed, if the bag is dropped and stepped on then the pacifier will be crushed. The bag also cannot be sanitized properly in the dishwasher. There are no strong and hygienic storage solutions provided for this purpose and this is why we decided to design a Pacifier storage container that solves all of these problems. Our Pacifier storage container is strong safe and light.

### BRIEF SUMMARY OF THE INVENTION

Our Baby Pacifier Holder is designed specifically to provide a compact storage solution for a baby pacifier. A safe and clean storage solution. The container has 2 different sized compartments divided to separate clean from dirty. The lids allow the compartments to ‘breathe.’ The container will be lightweight yet strong, BPA free and dishwasher safe for easy sanitizing. The chunky, knurled easy to open lids have a short screw thread to allow easy and quick opening. The Silicone ring allows attachment of a lanyard or strap. It is also an identifying mark to distinguish between clean and dirty sections. This will be beneficial to partially sighted users or if it is used in low light or dark situations.

The Method of Manufacture.

The container will be made from 2 moulds. The first mould will be for the main container and the second mould will be for the lids'. The factory manufacturing the container will only use new virgin Polypropylene plastic. It will be made by injection mould to the exact specifications as follows. The thickness of the container and internal divider will be 3 mm. The exterior of the lids will be 5 mm in thickness, the interior will be 3 mm. The length of the container will be 170 mm and the diameter will be 75 mm. The weight of the container will be approx 200 g. The collar/ring will be made from Silicone rubber—4 mm in thickness and 70 mm inside diameter. This is designed to stretch and fit the 75 mm diameter container. The ring will be stretched to fit tightly and snug on the container.

### BRIEF DESCRIPTION OF THE SEVERAL VIEWS OF THE DRAWING

Exploded View—Page 1 of diagram.

FIG. 1. Thick plastic lid with air hole for ventilation.

FIG. 2. Knurled ridges for easy opening of lid.

FIG. 3. Silicone rubber ring/collar for attachment of a lanyard or strap.

FIG. 4. Large 1^{st} compartment for storage of 2 clean pacifiers

FIG. 5. Smaller 2^{nd} compartment for storage of 1 dirty pacifier.

FIG. 6. Small sized screw thread for easy opening and closing of lid.

FIG. 7. Air hole in lid for ventilation.

FIG. 8. Indented Ring to distinguish between compartments.

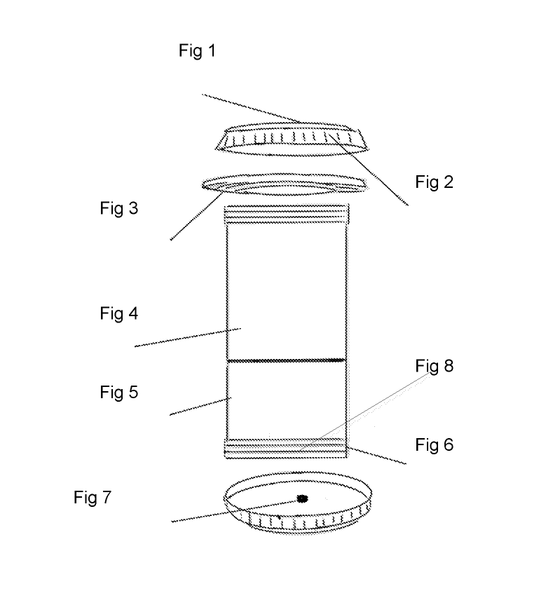

### DETAILED DESCRIPTION OF THE INVENTION

1. Our Baby Pacifier Holder is designed specifically to provide a compact storage solution for a baby pacifier.

2. Our Baby Pacifier Holder keeps the pacifiers safe and hygienically clean.

3. The holder will lightweight yet strong.

4. It will be made from polypropylene that is BPA free and Dishwasher Safe.

5. The container can be washed in the dishwasher to sterilize it when needed.

6. Each lid has a hole in the top to allow air flow and the container to ‘breathe’.

7. There is a section divider in the container that divides the storage compartments into 2 sections.

8. These 2 sections are of different sizes so that 2 clean pacifiers can be stored in the first section and there is room in the second section for a dirty pacifier.

9. The lids are chunky and knurled so that they are easy to grip and open.

10. The screw threads are short so that the container can easily be opened within 2 turns.

11. This feature will be extremely invaluable for parents who struggle to try to hold bags of shopping or other items in their arms while trying to find a pacifier for their crying baby.

12. Our lids will make it so much easier to open the container to take out a pacifier to comfort or soothe a crying child.

13. The top larger section of the container has an indented circle on it so that the larger section can be easily identified either in the dark, in low light situations or if the parent is partially sighted. This marking will enable the user to find the correct section where the clean pacifiers are stored.

14. There will also be a ring/collar which is made from strong silicone rubber. This ring/collar sits below the lid and has 2 holes, one on each end (diagram 4) the holes in the collar enable a hook or lanyard strap to be fitted for carrying the container.

1) A container specifically made to store baby pacifiers, soothers or dummies.

2) The container recited in claim 1 is designed to be a modern cylinder shape. This shape is to enable easy storage in a diaper bag or it can comfortably fit or slide into most spaces.

3) The container recited in claim 1 has a diameter which is large enough to fit all different kinds and sizes of pacifiers, soothers or dummies.

4) The container recited in claim 1 has 2 sectioned divided compartments to protect the clean pacifiers from used ones.

5) The container recited in claim 1 has 2 compartments which are of different lengths.

6) The container recited in claim 1 has 2 screw top lids, one at either end.

7) The container recited in claim 1 has screw top lids with air holes to ensure adequate air ventilation and fast drying of rinsed pacifiers.

8) The container recited in claim 1 has screw top lids that are ridged and knurled so that they are easy to grip and undo.

9) The container recited in claim 1 has screw top lids that can be opened within 2 or 3 turns.

10) The container recited in claim 1 has screw top lids that can be opened within 2 or 3 turns as the screw thread on each end is a short thread.

11) The container recited in claim 1 has a silicone ring that fits around the container just below the lid to determine which section of the container holds clean or dirty pacifiers (This is extremely useful for partially sighted persons or if used in low light)

12) The container recited in claim 1 is made from BPA free Virgin Polypropylene Plastic.

13) The container recited in claim 1 is dishwasher safe. All parts are dishwasher safe.

14) The container recited in claim 1 has a silicone rubber collar that fits snugly around the top of the container under the lid.

15) The container recited in claim 1 has a silicone rubber collar with holes that can be used to attach a lanyard or strap.
